(19) United States
(12) Patent Application Publication
(10) Pub. No.: US 2010/0157142 A1
(43) Pub. Date: Jun. 24, 2010

(54) CAMERA MODULE AND METHOD OF MANUFACTURING THE SAME

(75) Inventors: Jin Mun RYU, Hwaseong (KR); Byung Nam Park, Suwon (KR); Sang Jin Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/490,893

(22) Filed: Jun. 24, 2009

(30) Foreign Application Priority Data
Dec. 18, 2008 (KR) 10-2008-0129226

(51) Int. Cl. H04N 5/225; B23P 11/00

(52) U.S. Cl. 348/373; 29/428; 348/E05.024

(57) ABSTRACT

A camera module according to an aspect of the invention may include: a housing supporting movements along an optical axis of a lens barrel having a lens therein; a board having an image sensor collecting light incident upon the lens to form an image, and fixed to the housing; filter glass provided within the housing, arranged above the board and creating a space within which the image sensor is provided; and a dust dam provided within the space, the dust dam onto which foreign objects entering the image sensor are stuck so as to prevent the movements of the foreign objects.

### CROSS-REFERENCE TO RELATED APPLICATIONS

This application claims the priority of Korean Patent Application No. 2008-0129226 filed on Dec. 18, 2008, in the Korean Intellectual Property Office, the disclosure of which is incorporated herein by reference.

### BACKGROUND OF THE INVENTION

1. Field of the Invention

The present invention relates to camera modules and a method of manufacturing the same, and more particularly, to a camera module and a method of manufacturing the same that can prevent foreign objects from entering an image sensor.

2. Description of the Related Art

As camera modules that capture images or video are generally integrated into mobile terminals, such as cell phones or PDAs, mobile terminals having camera modules mounted thereon can serve as multimedia convergence devices.

Compact camera modules (CCMs) have currently been applied to various kinds of IT systems including toy cameras and portable mobile communications terminals, such as camera phones, PDAs and smart phones. These camera modules are being manufactured using image sensors, such as CCD or CMOS sensors, as the main components. A camera module collects light from an object to form an image using an image sensor, stores data in a memory provided within a system, and displays an image of the data on a display device, such as a PC monitor or an LCD provided in the system.

The image sensor is vulnerable to foreign objects, which are the biggest casual factor in the camera module defects. As the pixel density of camera modules has increased and the pixel size of image sensors has decreased, fine foreign objects that are much smaller the size of currently problematic foreign objects can cause defects.

Foreign objects may encroach upon camera modules when they are being manufactured. Foreign objects having been attached to raw materials may not be completely removed and may then be assembled into the camera modules. A device body, filter glass and a PCB can also generate foreign objects.

Therefore, there is an urgent need to prevent the occurrence of image sensor defects caused by foreign objects.

### SUMMARY OF THE INVENTION

An aspect of the present invention provides a camera module and a method of manufacturing the same that can prevent foreign objects from entering an image sensor by providing an adhesive dust dam so that foreign objects are stuck between a board and filter glass.

According to an aspect of the present invention, there is provided a camera module including: a housing supporting movements along an optical axis of a lens barrel having a lens therein; a board having an image sensor collecting light incident upon the lens to form an image, and fixed to the housing; filter glass provided within the housing, arranged above the board and creating a space within which the image sensor is provided; and a dust dam provided within the space, the dust dam onto which foreign objects entering the image sensor are stuck so as to prevent the movements of the foreign objects.

The dust dam may be disposed on the image sensor or the board and be separated from the filter glass by a space providing a foreign object catchment passage.

The dust dam may be arranged on the board and the image sensor and be separated from the filter glass by a space providing a foreign object catchment passage.

The dust dam be arranged on the filter glass and be separated from the board, the image sensor or the board and the image sensor by a space providing a foreign object catchment passage.

The dust dam may be cured by ultraviolet light or heat.

According to another aspect of the present invention, there is provided a method of manufacturing a camera module, the method including: mounting an image sensor onto a board; dispensing dust dam-forming materials onto the board, the image sensor or the board and the image sensor; and bonding the board having the dust dam-forming materials dispensed thereon to the housing.

The method may further include curing the dust dam-forming materials after the dispensing of the dust dam-forming materials.

The dust dam-forming materials may be dispensed to a height to define a space between the dispensed dust dam-forming materials and the filter glass inside the housing to form a foreign object catchment passage.

According to still another aspect of the present invention, there is provided a method of manufacturing a camera module, the method including: mounting an image sensor onto a board; dispensing dust dam-forming materials onto filter glass disposed within a housing or the filter glass and the housing; and bonding the housing having the dust dam-forming materials dispensed thereon to the board.

The method may further include curing the dust dam-forming materials after the dispensing of the dust dam-forming materials.

The dust dam-forming materials may be dispensed to a height to define a space between the dispensed dust dam-forming materials and the image sensor, the board or the image sensor and the board to form a foreign object catchment passage.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a camera module according to an exemplary embodiment of the invention;

FIG. 2 is an enlarged view illustrating a first example of a portion A of the camera module, shown in FIG. 1;

FIG. 3 is an enlarged view illustrating a second example of the portion A of the camera module, shown in FIG. 1;

FIGS. 4A through 4D are cross-sectional views illustrating the process flow of a method of manufacturing a camera module according to an exemplary embodiment of the invention; and

FIGS. 5A through 5D are cross-sectional views illustrating the process flow of a method of manufacturing a camera module according to another exemplary embodiment of the invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

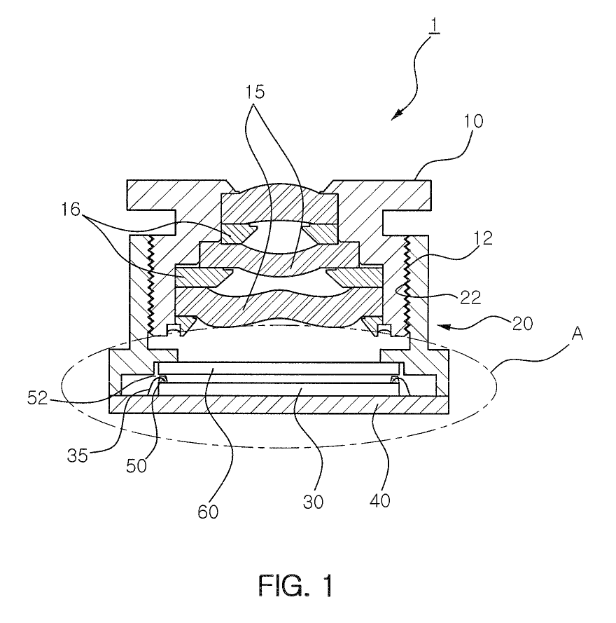

FIG. 1 is a schematic cross-sectional view illustrating a camera module according to an exemplary embodiment of the invention.

Referring to FIG. 1, a camera module 1 according to this embodiment includes a housing 20, a board 40, filter glass 60 and dust dams 50.

The housing 20 supports movements along the optical axis of a lens barrel 10 having one or more lenses 15 provided therein.

The lenses 15 are arranged in the lens barrel 10 along the optical axis. The lens barrel 10 is a lens receiving unit that has a hollow cylindrical shape having a predetermined space within it. One or more spacers 16 may be provided between the lenses 15 so that the lenses 15 can be arranged at predetermined intervals.

A male screw 12 is formed on an outer circumferential surface of the lens barrel 10, and a female screw 22 is formed on the inside of the housing 20. The lens barrel 10 and the housing 20 are connected to each other using these screws so that the lens barrel 10 can move along the optical axis.

An image sensor 30 is mounted onto the board 40 and covers the lower surface of the housing 20. The image sensor 30 collects light incident upon the lenses 15 to form an image.

The filter glass 60 filters infrared rays of light passing through the lenses 15, and is disposed inside the housing 20 and provided above the board 40. The image sensor 30 is covered by the filter glass 60 so that a space is created between the board 40 and the filter glass 60.

The dust dams 50 are provided within the above space so that foreign objects entering the image sensor 30 are stuck onto the dust dams 50 to thereby prevent the movements of the foreign objects.

The dust dams 50 are provided to prevent foreign objects, which may intrude while the camera module 1 is being manufactured, or foreign objects left in the device body, the filter glass or the board from being introduced into the image sensor 30. In particular, the dust dams 50 are formed of materials that are cured by ultraviolet light or heat and have adhesiveness. The dust dams 50 are disposed at the edges of activation areas of the image sensor 30. Foreign objects inside and outside the image sensor 30 are stuck onto the dust dams 50 by the movements of the camera module 1.

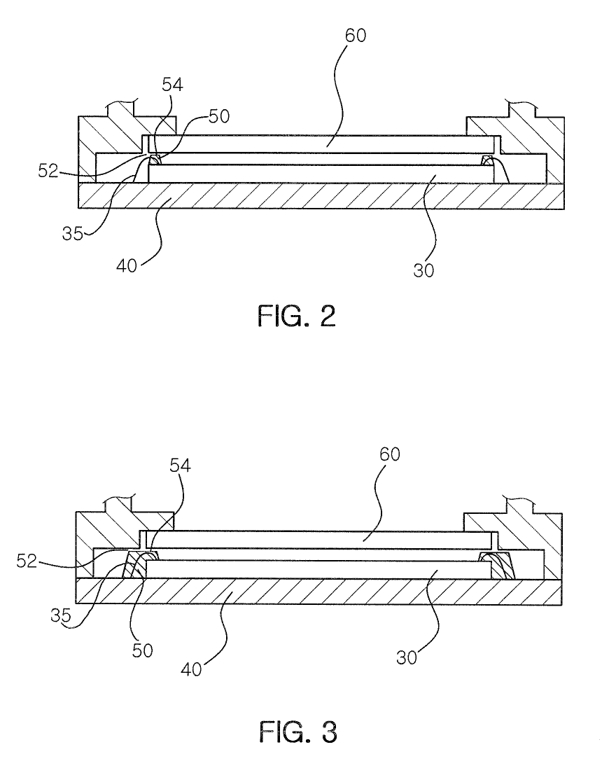

FIG. 2 is an enlarged view illustrating a first example of a portion A of the camera module, shown in FIG. 1. FIG. 3 is an enlarged view illustrating a second example of the portion A of the camera module, shown FIG. 1.

In FIG. 2, the dust dams 50 are disposed on the image sensor 30 and are separated from the filter glass 60 by a space to provide a foreign object catchment passage 52. In FIG. 3, the dust dams 50 are provided on both the image sensor 30 and the board 40 and are separated from the filter glass 60 by a space providing the foreign object catchment passage 52.

The dust dams 50 may be disposed at any location as long as it is provided between the board 40 and the filter glass 60. Alternatively, the dust dams 50 may be disposed on the filter glass 60.

Further, since the dust dams 50 are formed by dispensing adhesive materials for dust dams (dust dam-forming materials), the top of the dust dams 50 may be rounded. As an upper surface 54 of the dust dam 50 is provided in the foreign object catchment passage 52, foreign objects can be stuck onto the upper surface 54 while moving. As a result, in comparison to building partitions, adhesive regions onto which foreign objects are stuck can increase.

Hereinafter, a method of manufacturing the above-described camera module will be described in detail.

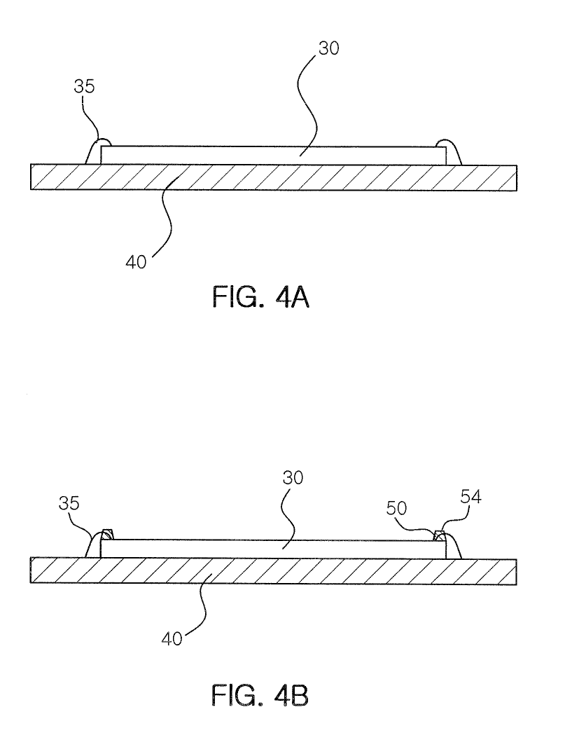

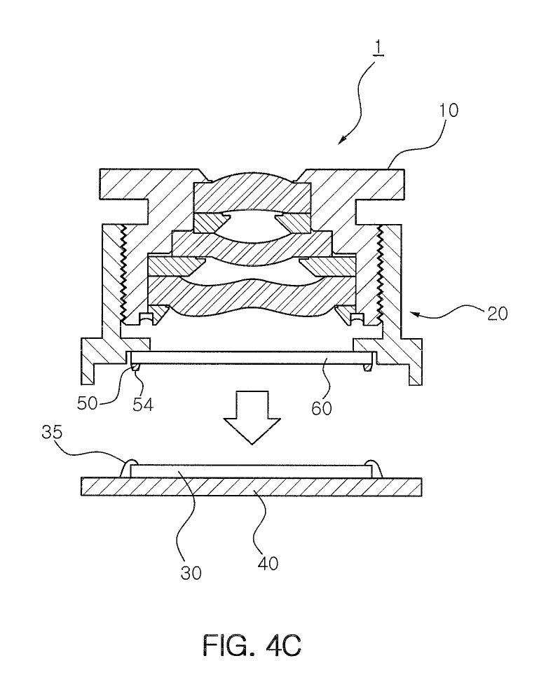

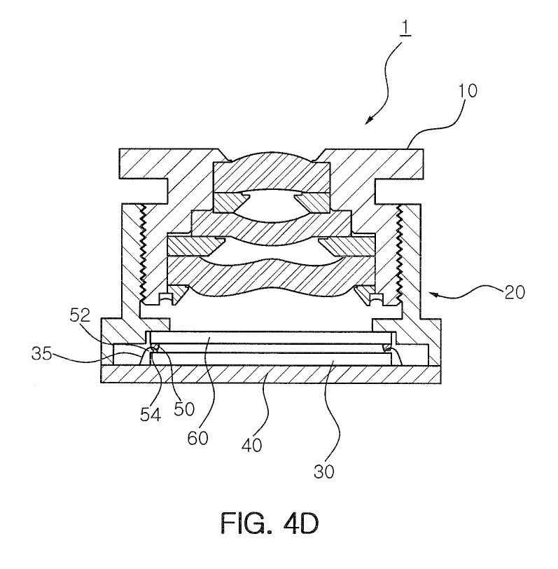

FIGS. 4A through 4D are cross-sectional views illustrating the process flow of a method of manufacturing a camera module according to an exemplary embodiment of the invention.

Referring to FIGS. 4A through 4D, a method of manufacturing a camera module according to this embodiment includes mounting the image sensor 30 onto the board 40 and bonding the image sensor 30 and the board 40 to each other by wires 35 (FIG. 4A), dispensing materials for dust dams onto the upper surface of the image sensor 30 to thereby form the dust dams 50 (FIG. 4B), and bonding the board 40, onto which the materials for dust dams are dispensed, to the housing 20 (FIGS. 4C and 4D).

The dust dam-forming materials may be dispensed onto the image sensor 30, the board 40 or the board 40 and the image sensor 30, thereby forming the dust dams 50.

The dust dam-forming materials are dispensed and then cured to form the dust dams 50. Alternatively, after the dust dam-forming materials are cured, the dust dams 50 may be bonded to the housing 20.

The dust dam-forming materials may be dispensed to a predetermined height to define a space between the dispensed dust dam-forming materials and the filter glass 60 inside the housing 20 to form the foreign object catchment passage 52.

The wires 35 may have a low loop profile without adversely affecting wire bonding using the wires 35 so as to smoothly dispense the dust dam-forming materials.

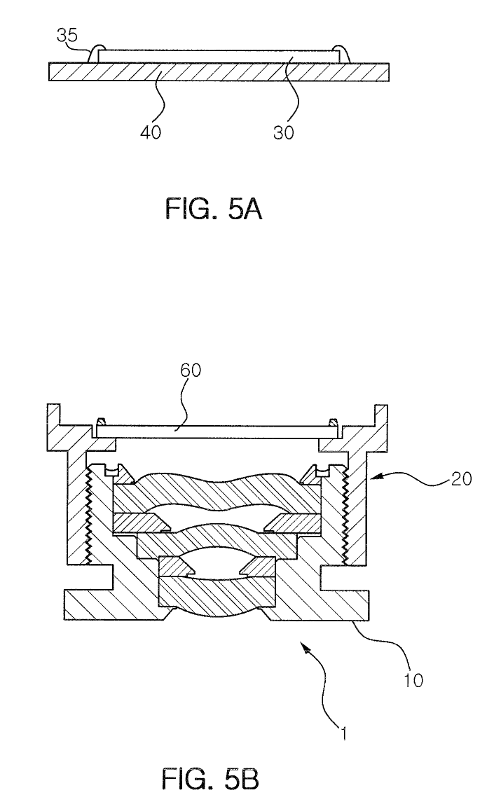

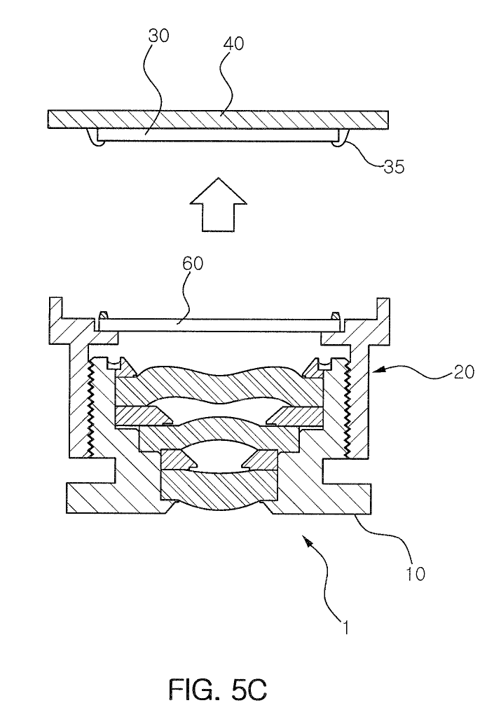

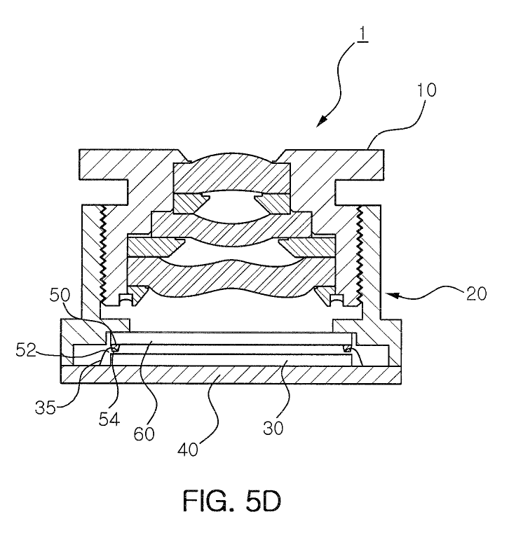

FIGS. 5A through 5D are cross-sectional views illustrating the process flow of a method of manufacturing a camera module according to another exemplary embodiment of the invention.

This embodiment is the same as the embodiment, illustrated with reference to FIGS. 4A through 4D, except that the dust dam-forming materials are dispensed onto the surface of the filter glass 60 or the surfaces of the filter glass 60 and the housing 20 at the same time, which are then bonded to the board 40.

Thus, a description of the embodiment, illustrated with reference to FIGS. 4A through 4D, will replace the description of this embodiment.

As set forth above, according to a camera module and a method of manufacturing the same according to an exemplary embodiment of the invention, dust dams provided adjacent to an image sensor can prevent foreign objects, which may occur inside a housing of a camera module, from entering the image sensor.

Furthermore, as dust dams are formed of adhesive materials, foreign objects inside the dust dams are stuck onto the dust dams while they are moving, thereby preventing the occurrence of defects of a camera module.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module comprising:
a housing supporting movements along an optical axis of a lens barrel having a lens therein;
a board having an image sensor collecting light incident upon the lens to form an image, and fixed to the housing;
filter glass provided within the housing, arranged above the board and creating a space within which the image sensor is provided; and
a dust dam provided within the space, the dust dam onto which foreign objects entering the image sensor are stuck so as to prevent the movements of the foreign objects.

2. The camera module of claim 1, wherein the dust dam is disposed on the image sensor or the board and is separated from the filter glass by a space to provide a foreign object catchment passage.

3. The camera module of claim 1, wherein the dust dam is arranged on the board and the image sensor and is separated from the filter glass by a space to provide a foreign object catchment passage.

4. The camera module of claim 1, wherein the dust dam is arranged on the filter glass and is separated from the board, the image sensor or the board and the image sensor by a space to provide a foreign object catchment passage.

5. The camera module of claim 1, wherein the dust dam is cured by ultraviolet light or heat.

6. A method of manufacturing a camera module, the method comprising:
mounting an image sensor onto a board;
dispensing dust dam-forming materials onto the board, the image sensor or the board and the image sensor; and
bonding the board having the dust dam-forming materials dispensed thereon to the housing.

7. The method of claim 6, further comprising curing the dust dam-forming materials after the dispensing of the dust dam-forming materials.

8. The method of claim 6, wherein the dust dam-forming materials are dispensed to a height to define a space between the dispensed dust dam-forming materials and the filter glass inside the housing to form a foreign object catchment passage.

9. A method of manufacturing a camera module, the method comprising:
mounting an image sensor onto a board;
dispensing dust dam-forming materials onto filter glass disposed within a housing or the filter glass and the housing; and
bonding the housing having the dust dam-forming materials dispensed thereon to the board.

10. The method of claim 9, further comprising curing the dust dam-forming materials after the dispensing of the dust dam-forming materials.

11. The method of claim 9, wherein the dust dam-forming materials are dispensed to a height to define a space between the dispensed dust dam-forming materials and the image sensor, the board or the image sensor and the board to form a foreign object catchment passage.
